(19) United States
(12) Patent Application Publication
(10) Pub. No.: US 2011/0251858 A1
(43) Pub. Date: Oct. 13, 2011

(54) INSURANCE ALERT SYSTEM AND METHOD

(76) Inventors: Lars Christian Nielsen, Dallas, TX (US); Charles Jason Holloway, Flower Mound, TX (US)

(21) Appl. No.: 12/759,266

(22) Filed: Apr. 13, 2010

(51) Int. Cl. G06Q 40/00

(52) U.S. Cl. 705/4

(57) ABSTRACT

An insurance alert system comprises an alert module executable by a processor, the alert module configured to automatically interface with a plurality of different insurance providers for an insurance broker. The alert module is configured to obtain and aggregate alert data from the plurality of different insurance providers corresponding to customers of the insurance broker, the alert data corresponding to insurance policies of the customers with the respective insurance providers.

### BACKGROUND

Independent insurance agents or insurance brokers generally provide consumers with an insurance premium estimate (a.k.a., a rate quote) for a variety of types of insurance products (e.g., automobile insurance, health insurance, life insurance, home insurance, etc.). For example, a broker may interact with a number of different insurance providers using the Internet or other type of communications network. The broker provides information or values corresponding to one or more parameters related to a particular insurance product to the insurance provider (e.g., type of insurance sought, deductible amount; coverage amount; type of automobile; and the consumer's personal information, such as name, address, phone number, etc.). After the parameters have been entered, different insurance providers formulate an insurance premium estimate or rate quote based on the parameters provided by the broker. The rate quotes are then provided to the broker and, in turn, to the consumer.

### BRIEF DESCRIPTION OF THE DRAWINGS

The accompanying drawings incorporated in and forming a part of the specification illustrate several aspects of the present disclosure and, together with the description, serve to explain the principles of the present disclosure. In the drawings:

FIG. 1 is a schematic diagram illustrating an embodiment of an insurance alert system;

FIG. 2 is a block diagram illustrating an embodiment of a server in the insurance alert system of FIG. 1;

FIG. 3 is a flow diagram illustrating an embodiment of an insurance alert method; and

FIG. 4 is a diagram illustrating an embodiment of an alert data matrix generated by the alert system and method of FIGS. 1-3.

### DETAILED DESCRIPTION OF THE DRAWINGS

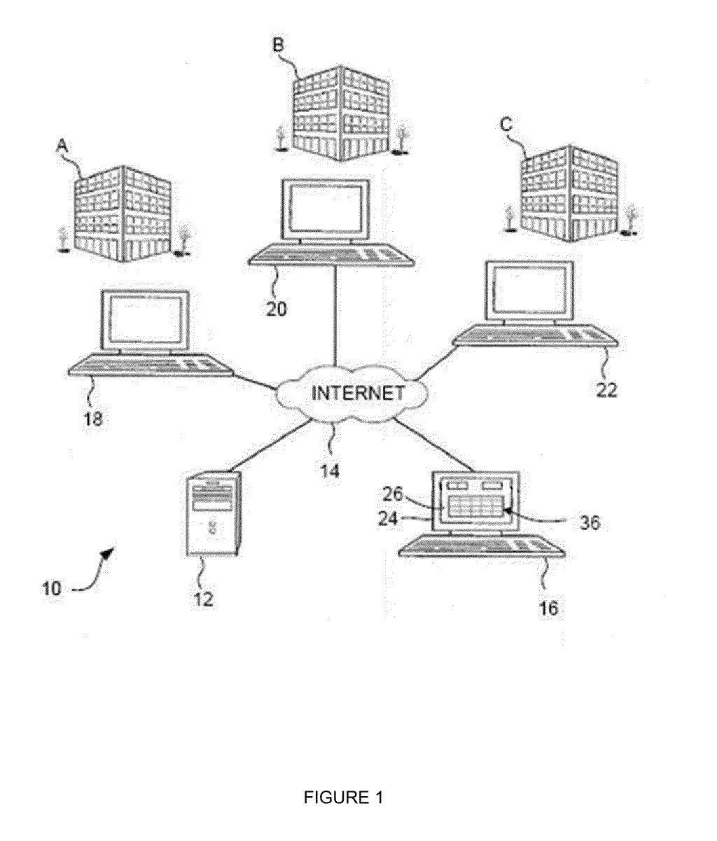

Referring now to FIG. 1, an embodiment of an insurance alert system 10 for providing alert information from one or more insurance providers to an insurance broker. As will be more fully explained below, system 10 enables the broker to obtain alert information from different insurance providers without having to independently access or log into each insurance provider's computer network or system. System 10 automatically retrieves, aggregates and provides the alerts for each insurance provider designated by the broker. A broker as used herein may be any person that sells or otherwise provides an insurance product to a consumer (e.g., independent of whether the seller is representing the interests of the consumer (e.g., broker) or the insurance provider (e.g., agent)).

In the embodiment illustrated in FIG. 1, system 10 comprises a server 12 operably coupled through a network 14 to a computer 16, a computer 18 of insurance provider A, a computer 20 of insurance provider B, and a computer 22 of insurance provider C. In the embodiment illustrated in FIG. 1, server 12 is a web server of an insurance broker. In some embodiments, server 12 is configured to receive requests through network 14 from a client computer such as, for example, computer 16. In that regard, server 12 may be equipped to accommodate data formatted as Hypertext Markup Language (HTML) and communicated using a standard communication protocol such as, for example, Hypertext Transfer Protocol (HTTP). Server 12 may be equipped for wireless communication, wired communication, or a combination thereof, over network 14. In some embodiments, server 12 is a computing device other than a web server. For example, server 12 may be a desktop or laptop computer or any other type of computing platform equipped with appropriate hardware and/or software. Also, while server 12 is depicted in FIG. 1 as receiving requests from a single client computer 16, additional client computers 16 may be present and accommodated by server 12. Multiple servers 12 may also be used.

In FIG. 1, network 14 is the Internet, which is a global system of interconnected computer networks that interchange data by packet switching using the standardized Internet Protocol Suite (TCP/IP). In some embodiments, network 14 may be another suitable network such as, for example, a wide area network (WAN), local area network (LAN), intranet, extranet, etc., or any combination thereof. Network 14 is configured to facilitate wireless communication, wired communication, or a combination thereof, between server 12, computer 16, computer 18, computer 20, and computer 22.

In FIG. 1, computer 16 is illustrated as a desktop personal computer (PC). However, it should be understood that computer 16 may be a variety of other network-enabled computing devices such as, for example, a server, laptop computer, notebook computer, tablet computer, personal digital assistant (PDA), wireless handheld device, cellular phone, and/or thin-client. Computer 16 may be equipped for wireless communication, wired communication, or a combination thereof, over network 14.

In addition to other various types of software, computer 16 generally includes an Internet browser installed thereon. The browser of computer 16 is generally capable of displaying on a display 24 of the computer 16 an HTML document. In particular, the browser is capable of displaying an interface screen 26 (e.g., in the form of a graphical user interface (GUI)), which is based on the HTML document generated by server 12.

Still referring to FIG. 1, the browser of computer 16 is capable of displaying on display 24 alert data 36. Alert data 36 includes alert information from one or more insurance providers (e.g., insurance provider A, insurance provider B, and/or insurance provider C). The alert data 36 may provide the insurance broker with a variety of types of information associated with customers of the insurance broker that has been generated by the corresponding insurance carriers to which the customer of the insurance broker has subscribed or otherwise purchased an insurance product. For example, alert data 36 may include information that is generated based on some activity related to a customer or a customer's insurance policy associated with a particular insurance carrier such as, but not limited to, a policy change, a claim, a renewal, a purchase of a policy, or a cancellation of a policy. In some embodiments, the alert data 36 may be conveyed to the insurance broker without employing the browser. For example, alert data 36 may be incorporated into an electronic mail message, included as an attachment to an electronic mail message, delivered via facsimile, sent as a text message, accessed through a hyperlink, or communicated using another format or method.

Even though generally not affiliated with one another, for the sake of convenience in the discussion below, each of computer 18, computer 20, and computer 22 in FIG. 1 may be collectively referred to as computers 18, 20 and 22 while their affiliated insurance providers may be collectively referred to as respective insurance providers A, B and C. Each of computers 18, 20 and 22 may be a server, web server, some type of personal computer (PC), or other computer device equipped with appropriate hardware and/or software for communication with server 12 through network 14. Also, while three computers 18, 20 and 22 and three insurance providers A, B and C are illustrated in FIG. 1, more or fewer computers and insurance providers may be accessible to server 12 through network 14.

Each of computers 18, 20 and 22 is equipped with software and/or hardware for generating alert information based on a given parameter or set of criteria. For example, an alert generation engine, which may be executed by a processor or processing system, may be installed on computers 18, 20 and 22 and configured to generate alert information based on an event associated with a policy of a customer of a particular insurance carrier. As described above, the policy event may be a claim, a renewal, a change in a policy, a purchase or cancellation of a policy, or other type of policy-related event. The particular hardware and/or software on each of computers 18, 20 and 22 may be independently developed by the particular insurance provider A, B and C. In other words, each insurance provider A, B and C may have their own proprietary system, method, or algorithm for generating alerts. Computers 18, 20 and 22 are each equipped for wireless communication, wired communication, or a combination thereof, over network 14. Each of computers 18, 20 and/or 22 may also be configured to enable an insurance broker to register therewith to enable the user/broker to interface with the corresponding computers 18, 20 and/or 22 vi computer 16 and/or server 12.

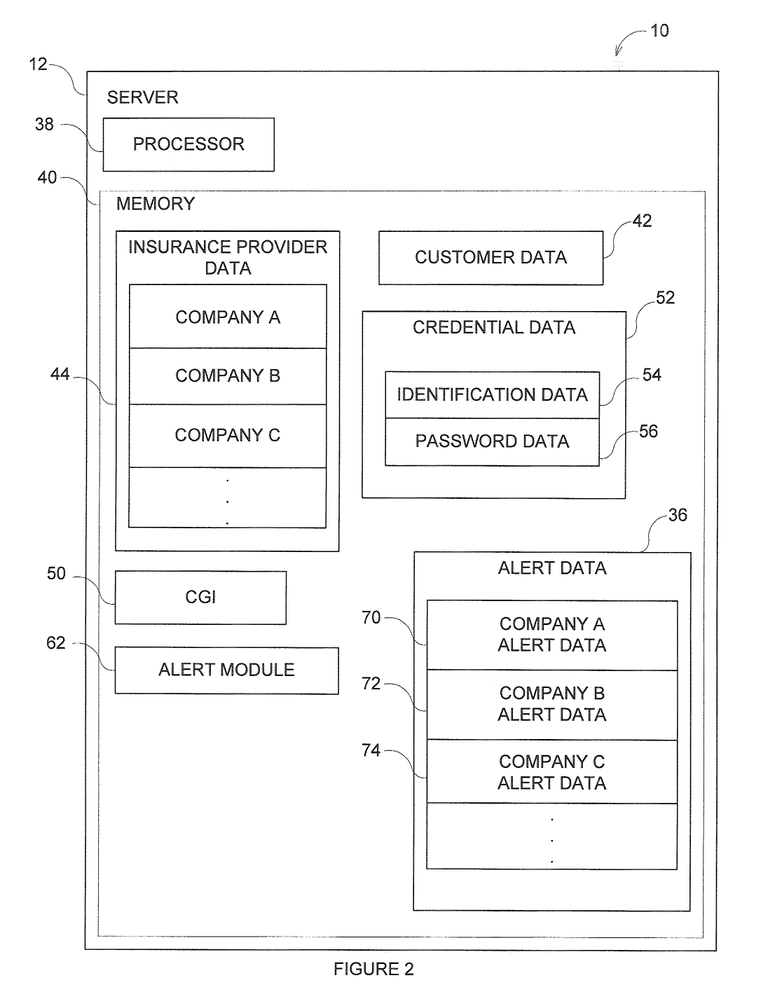

Referring now to FIG. 2, server 12 is illustrated in further detail. In the embodiment illustrated, server 12 includes a processor 38 and a memory 40. In general, processor 38 processes and/or executes instructions (e.g., software code) and performs logic operations while memory 40 temporarily or permanently stores information that may be retrieved therefrom. In FIG. 2, memory 40 includes customer 42 and insurance provider data 44.

Customer data 42 comprises information associated with a particular customer of the insurance broker. Insurance provider data 44 comprises information associated with different providers of insurance offerings (e.g., Companies A, B and C). The information stored as insurance provider data 44 may include identification information of the different insurance providers, relational information indicating the customers indicated by customer data 42 having insurance policies with the particular insurance provider, or other types of information associated with the particular insurance providers. Information associated with different insurance providers may be automatically updated in response to updates automatically received from computers 18, 20 and 22 (e.g., without a prompt or request from server 12). In some embodiments, information may be collected from insurance providers according to a predetermined schedule to periodically update information stored in memory 40.

Because of an interface and/or data transferred between server 12, computer 18, computer 20, and computer 22, memory 40 may also include a common gateway interface (CGI) 50. CGI 50 has the ability to receive and process non-standardized data from multiple sources and to output standardized data. In particular, CGI 50 of server 12 may be configured to output a document or data, such as alert data 36, in an HTML, XML or any other type of format to facilitate communications with computers 18, 20 and 22, receive alert data 36 from computers 18, 20 and 22, and transfer such information to other sources.

In the embodiment illustrated in FIG. 2, memory 40 also comprises credential data 52, alert data 36 and an alert module 60. Credential data 52 comprises credential information for a particular user or insurance broker to enable access to each of the different insurance carrier computer systems by or on behalf of an insurance broker, such as computers 18, 20 and 22. For example, in the embodiment illustrated in FIG. 2, credential data 52 comprises identification data 54 and password data 56. Identification data 54 may comprise a username or other identification information associated with a particular insurance broker for accessing a computer system of a particular insurance provider. Password data 56 may comprise a password or other type of secure access information corresponding to a particular user or insurance broker. It should be understood that credential data 52 may include distinct information corresponding to each insurance provider.

Alert module 62 functions to interface with computers 18, 20 and/or 22 and obtain alert data 36 from insurance companies A, B and/or C corresponding to customers of the user/broker. In some embodiments, alert module 62 accesses customer data 42 and identifies the customers of the user/broker that correspond to a particular insurance provider. In some embodiments, alert module 62 is software (e.g., a set of instructions and/or an algorithm) that, when executed by processor 38, generates and/or otherwise provides interface screen 26, receives and/or stores credential data 52 for accessing computers 18, 20 and/or 22, retrieves and/or receives alert data 36 from computers 18, 20 and/or 22, and displays or otherwise provides the alert data 36 to the insurance broker. In some embodiments, alert module 62 is some combination of software, hardware, and/or firmware.

Thus, in operation, an insurance broker may launch or otherwise cause the execution of alert module 62. In some embodiments, alert module 62 automatically accesses credential data 52 and automatically interfaces with computers 18, 20 and/or 22 to access and retrieve alert data 36 independently of broker interaction. In some embodiments, alert module 62 may be automatically activated upon the broker turning on or accessing computer 16. In some embodiments, alert module 62 remains interfaced with computers 18, 20 and/or 22 and retrieves/receives alert data 36 as the alert data 36 becomes available from the corresponding computers 18, 20 and/or 22 (e.g., real-time or near real-time event notification), thereby dynamically updating the alert data 36 in response to alert information becoming available at a respective insurance provider. In some embodiments, alert module 62 simultaneously, concurrently or serially submits credential data 52 to computers 18, 20 and/or 22 without user/broker action, thereby facilitating communications with computers 18, 20 and/or 22 without the need for the user/broker to manually log into each computer system of the respective insurance providers.

In some embodiments, alert module 62 may be configured to periodically access and retrieve alert data 36 from computers 18, 20 and/or 22 according to a desired or predefined schedule. For example, in some embodiments, alert module 62 may be configured to automatically interface with computers 18, 20 and/or 22 periodically without user or broker interaction to retrieve alert data 36. In other embodiments, alert module 62 may interface with computers 18, 20 and/or 22 in response to a prompt or request received from computers 18, 20 and/or 22. For example, in some embodiments, in response to receiving a signal from computers 18, 20 and/or 22 (e.g., a signal indicating an alert event has occurred, a signal indicating that alert data 36 is ready for download, a signal indicating that updated alert information is available, etc.), alert module 62 interfaces with computers 18, 20 and/or 22 to receive and/or retrieve alert data 36.

Alert module 62 obtains the alert information corresponding to the insurance providers and stores the alert data 36 in memory 40. In some embodiments, alert module 62 aggregates the alert information received from each insurance provider and displays the aggregated information to the user/broker via display 24. The alert information may also be stored and/or displayed according to the respective insurance provider (e.g., company A alert data 70, company B alert data 72, company C alert data 74, etc.). The alert data 36 may also be displayed, organized or otherwise manipulated according to other factors (e.g., by type of event, customer name, type of insurance product, etc.).

In some embodiments, alert module 62 may automatically perform additional operations based on the type of alert received. For example, in some embodiments, in response to receiving an alert indicating a claim for insurance coverage/reimbursement, alert module 62 may automatically send a survey to the customer (e.g., via electronic mail or otherwise) requesting feedback on how that particular insurance carrier handled the claim. In some embodiments, in response to receiving an alert indicating a cancellation of a policy, alert module 62 may automatically send a communication (e.g., electronic mail, text message, etc.) to the customer on behalf of the broker thanking the customer for past patronage requesting future patronage. If a policy renewal alert is received, alert module 62 may evaluate any premium difference and, if the premium has increased by some threshold value, may automatically run or cause to be run additional quotation services for different insurance providers. If a policy renewal alert is received, alert module 62 may automatically send a communication to the customer on behalf of the broker thanking the customer for continued patronage and/or informing the customer of additional offerings (e.g., other types of insurance products). In some embodiments, alert module 62 may be configured to provide an interface or other method for enabling the broker to specify a particular action to automatically initiate based on the different types of alerts. Thus, it should be understood that a variety of different responses may be automatically triggered in response to receiving different types of alerts.

In the embodiment illustrated in FIG. 2, alert module 62, memory 40, and processor 38 reside on server 12. However, in some embodiments, alert module 62, memory 40, and/or processor 38 may be incorporated into another device and/or remotely located relative to server 12 and/or one another. In some embodiments, alert module 62 is stored on a tangible, computer-readable medium such as, for example, a compact disk (CD), a digital versatile disk (DVD), which is sometimes referred to as a digital video disk, a flash drive, and the like. Further, it should be understood that alert module 62, and the information used by alert module 62 may be located remote from server 12 and/or processor 38.

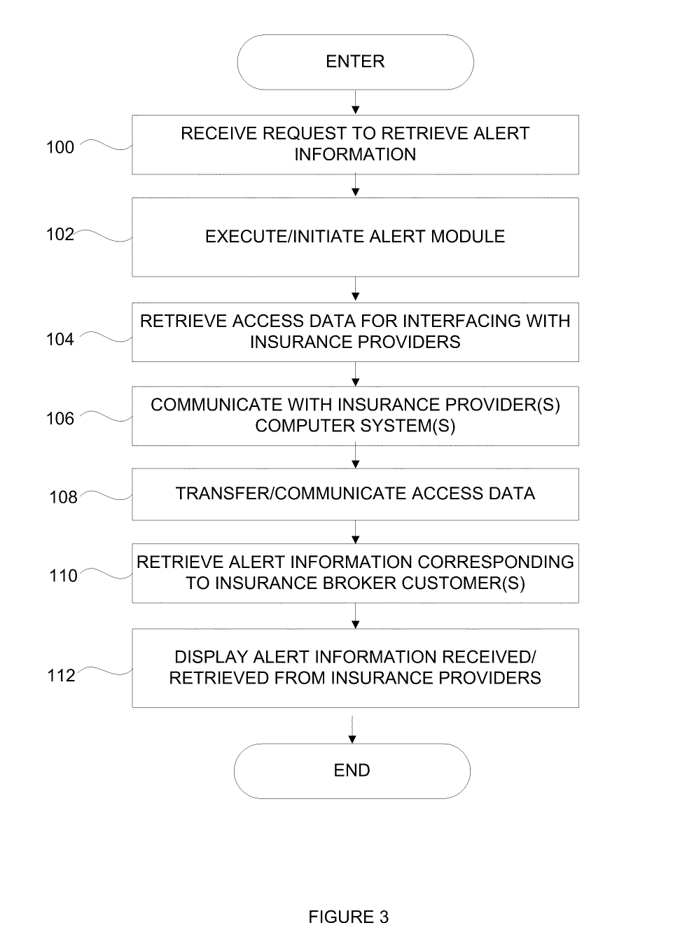

FIG. 3A is a flow diagram illustrating an embodiment of a method for obtaining insurance alert information from insurance providers. At block 100, server 12 and/or computer 16 receives a request initiated by the user/broker via the browser on computer 16 for alert information corresponding to customers of the user/broker. At block 102, alert module 62 is executed by processor 38 of server 12. In some embodiments, alert module 62 may display interface screen 26 to the user/broker on display 24 of computer 16 to enable the user/broker to input and store credential data 52 corresponding to one or more insurance providers. At block 104, alert module 62 causes server 12 to retrieve credential data 52 corresponding to one or more insurance providers. In some embodiments, alert module 62 may be configured to enable the user/broker to designate the particular insurance providers from which alert information is desired. However, it should be understood that in some embodiments, alert module 62 may be configured to automatically seek to interface with each computer system of an insurance provider that the user/broker has registered with for obtaining alert information.

At block 106, alert module 62 causes processor 38 to establish a communication session with corresponding computers 18, 20 and/or 22. At block 108, alert module 62 causes processor 38 to transfer or otherwise communicate credential data 52 associated with the corresponding insurance providers to respective computers 18, 20 and/or 22. At block 110, alert information is obtained from the corresponding computers 18, 20 and/or 22. In some embodiments, alert module 62 compares the alert information with any previously obtained alert information stored in memory 40 and updates and/or otherwise modifies the stored alert data 36 with the updated alert information. At block 112, alert module 62 causes processor 38 to display the alert information on display 24.

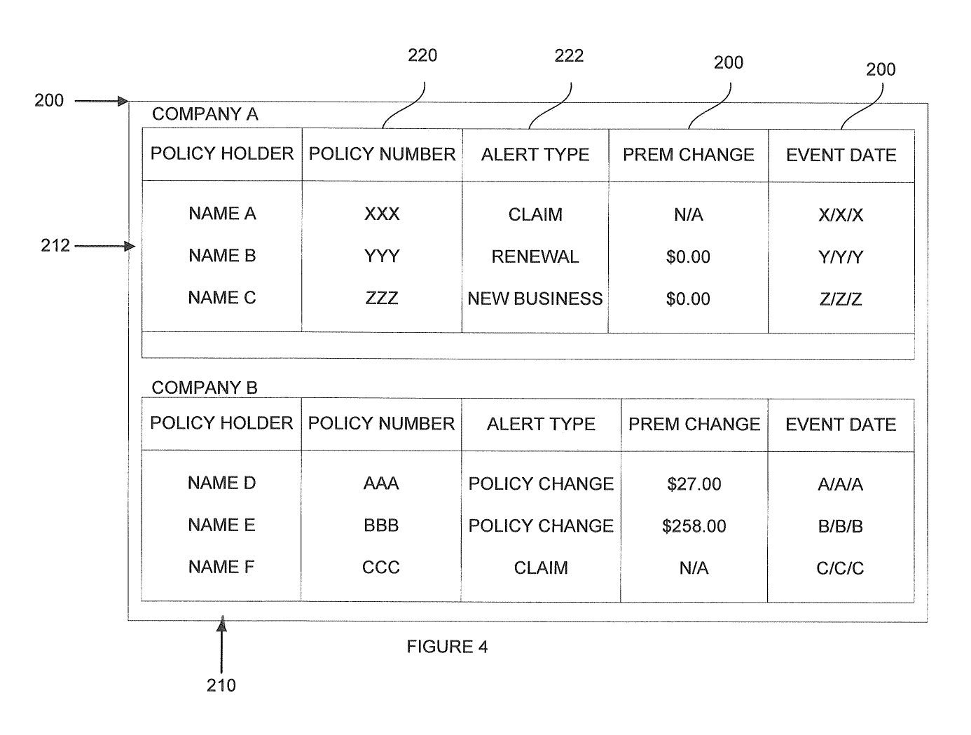

FIG. 4 is a diagram illustrating an embodiment of an alert data matrix 200 generated by alert module 62. In the illustrated embodiment, alert data matrix 200 is a compilation or collection of alert data 36 obtained from different insurance providers representing customers of the user/broker having policies with corresponding insurance providers. Alert data 36 represented in alert data matrix 200 may be organized in a table or matrix format. In some embodiments, alert data matrix 200 may be configured as a chart, graph, or other graphical representation of information. In the embodiment illustrated in FIG. 4, alert data matrix 200 has been generated for two different insurance providers (e.g., Company A and Company B).

In the embodiment illustrated in FIG. 4, alert data matrix 200 includes event information related to different consumers and the respective insurance policies of such consumers. For example, in the illustrated embodiment, alert data matrix 200 includes the customer or policyholder names along a vertical axis 210 and various types of alert information corresponding to each policyholder along a horizontal axis 212. In the embodiment illustrated in FIG. 4, the alert information includes a policyholder number 220, a type of alert 222 related to the particular policy, a premium change designation 224 indicating whether the event cause a change in the policy premium, and an event date 226 indicating a date that the particular event occurred. As FIG. 4 illustrates, the alert information is aggregated for multiple insurance providers. However, it should be understood that the types of alert information and its presentation may be varied, manipulated, or combined in any manner to produce different results.

It should be understood that in the described method, certain functions may be omitted, accomplished in a sequence different from that depicted in FIG. 3, or simultaneously performed. Also, it should be understood that the method depicted in FIG. 3 may be altered to encompass any of the other features or aspects as described elsewhere in the specification. Further, embodiments may be implemented in software and can be adapted to run on different platforms and operating systems. In particular, functions implemented by alert module 62, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium.

What is claimed is:

1. An insurance alert system, comprising:
an alert module executable by a processor, the alert module configured to automatically interface with a plurality of different insurance providers for an insurance broker, the alert module configured to obtain and aggregate alert data from the plurality of different insurance providers corresponding to customers of the insurance broker, the alert data corresponding to insurance policies of the customers with the respective insurance providers.

2. The system of claim 1, wherein the alert module is configured to display the aggregated alert data.

3. The system of claim 1, wherein the alert module is configured to automatically submit credential data for the insurance broker to the respective insurance providers.

4. The system of claim 1, wherein the alert module is configured to obtain an event date corresponding to an event related to a respective insurance policy.

5. The system of claim 1, wherein the alert module is configured to obtain premium change information corresponding to an event associated with an insurance policy.

6. The system of claim 1, wherein the alert module is configured to dynamically update the alert data in response to event information available from a respective insurance provider.

7. The system of claim 1, wherein the alert module is configured to periodically interface with the plurality of different insurance providers according to a predefined schedule to obtain the alert data.

8. An insurance alert method, comprising:
automatically interfacing with a plurality of different insurance providers for an insurance broker;
obtaining alert data from the plurality of different insurance providers corresponding to customers of the insurance broker, the alert data corresponding to insurance policies of the customers with the respective insurance providers; and
providing the insurance broker with an aggregated display of the alert data.

9. The method of claim 8, further comprising automatically submitting credential data for the insurance broker to the respective insurance providers.

10. The method of claim 8, further comprising obtaining an event date corresponding to an event related to a respective insurance policy.

11. The method of claim 8, further comprising obtaining premium change information corresponding to an event associated with an insurance policy.

12. The method of claim 8, further comprising dynamically updating the alert data in response to event information available from a respective insurance provider.

13. The method of claim 8, further comprising periodically interfacing with the plurality of different insurance providers according to a predefined schedule to obtain the alert data.

14. The method of claim 8, further comprising automatically responding to the alert data based on a type of alert received from a respective insurance provider.

15. A computer program product having stored thereon an instruction set to be executed by a processor, the instruction set, when executed by the processor, causes the processor to:
automatically interface with a plurality of different insurance providers for an insurance broker;
obtain alert data from the plurality of different insurance providers corresponding to customers of the insurance broker, the alert data corresponding to insurance policies of the customers with the respective insurance providers; and
provide the insurance broker with an aggregated display of the alert data.

16. The computer program product of claim 15, wherein the instruction set, when executed by the processor, causes the processor to automatically submit credential data for the insurance broker to the respective insurance providers.

17. The computer program product of claim 15, wherein the instruction set, when executed by the processor, causes the processor to obtain an event date corresponding to an event related to a respective insurance policy.

18. The computer program product of claim 15, wherein the instruction set, when executed by the processor, causes the processor to obtain premium change information corresponding to an event associated with an insurance policy.

19. The computer program product of claim 15, wherein the instruction set, when executed by the processor, causes the processor to dynamically update the alert data in response to event information available from a respective insurance provider.

20. The computer program product of claim 15, wherein the instruction set, when executed by the processor, causes the processor to periodically interface with the plurality of different insurance providers according to a predefined schedule to obtain the alert data.
